(19) United States
(12) Patent Application Publication
(10) Pub. No.: US 2025/0273800 A1
(43) Pub. Date: Aug. 28, 2025

(54) ELECTRIC STORAGE DEVICE, AND VEHICLE

(71) Applicant: TOYOTA JIDOSHA KABUSHIKI KAISHA, Aichi-ken (JP)

(72) Inventors: Kazuhito KATO, Toyota-shi (JP); Yoshiro OBAYASHI, Toyota-shi (JP); Yosuke SHIMURA, Nagakute-shi (JP); Kenta MIYAHARA, Toyohashi-shi (JP); Takuya NOGUCHI, Toyota-shi (JP); Yuji KATAYAMA, Okazaki-shi (JP); Masaya OGURA, Hamamatsu-shi (JP); Ryutaro SUZUKI, Hamamatsu-shi (JP)

(21) Appl. No.: 18/991,708

(22) Filed: Dec. 23, 2024

(30) Foreign Application Priority Data
Feb. 22, 2024 (JP) 2024-025487

(51) Int. Cl. H01M 50/271; B60L 50/64; H01M 50/209; H01M 50/249

(52) U.S. Cl. CPC H01M 50/271; B60L 50/64; H01M 50/209; H01M 50/249; H01M 2220/20

(57) ABSTRACT

An electric storage device includes: a first case that houses a first cell group; and a second case that houses a second cell group. Each of the first cell group and the second cell group includes a plurality of electric storage cells that is connected in a first direction. The first case includes an opening portion at one end in a second direction orthogonal to the first direction. The first case and the second case are disposed such that the second case closes the opening portion of the first case.

### CROSS-REFERENCE TO RELATED APPLICATION

This application claims priority to Japanese Patent Application No. 2024-025487 filed on Feb. 22, 2024, incorporated herein by reference in its entirety.

### BACKGROUND

### 1. Technical Field

The present disclosure relates to an electric storage device that includes a plurality of electric storage cells, and vehicle.

### 2. Description of Related Art

Japanese Unexamined Patent Application Publication (Translation of PCT application) No. 2023-502457 (JP 2023-502457 A) discloses a battery (electric storage device) having a rectangular parallelepiped shape in which a length L is 400 mm to 2500 mm and the ratio (L/H) of the length L to a width H is 4 to 21.

### SUMMARY

In the electric storage device described in JP 2023-502457 A, a plurality of electrode sets (electric storage cells) that is connected in series and is arrayed on a line is disposed in a case (housing). Such an electric storage device includes an aggregation (cell group) of a plurality of electric storage cells that is electrically connected.

In the production of the above electric storage device, the cell group needs to be put in the case. For example, it is possible that the cell group is put in the case from an opening portion provided on the case, the opening portion of the case is subsequently closed by a lid member, and the case body and the lid member are joined. However, when the opening portion of the case is small, it is difficult to put the cell group in the case. Conversely, when the opening portion of the case is large, a large lid member (or many lid members) is necessary for closing the opening portion. The increase in the dimensions or number of components sometimes makes it difficult to produce the electric storage device, or causes the rise in production cost.

The present disclosure has been made for solving the above problem, and has an object to provide an electric storage device that makes it possible to restrain the increase in the dimensions or number of components and that is easily produced, and a vehicle.

As a mode of the present disclosure, the following electric storage device is provided.

(First Item) The electric storage device includes: a first case that houses a first cell group; and a second case that houses a second cell group. Each of the first cell group and the second cell group includes a plurality of electric storage cells that is connected in a first direction. The first case includes an opening portion at one end in a second direction orthogonal to the first direction. The first case and the second case are disposed such that the second case closes the opening portion of the first case.

In the above configuration, the opening portion of the first case that houses the first cell group is closed by the second case that houses another cell group (second cell group), and therefore, it is not necessary to separately provide a lid member for closing the opening portion of the first case. Thereby, the increase in the number of components is restrained. At least one face of the second case is formed so as to have such a size that the second cell group can be housed. Therefore, even when an opening portion having a size that allows the first cell group to easily pass is formed on the first case, the opening portion of the first case can be closed by the second case. In the above configuration, it is possible to provide an electric storage device that makes it easy to put the cell group in the case, that is, an electric storage device that is easily produced.

(Second Item) In the electric storage device according to the first item, each of the first case and the second case has a rectangular parallelepiped shape in which an opening portion is provided at one end in the second direction. Each of the first case and the second case includes a first face and a second face that are positioned at both ends in the first direction, and a third face, a fourth face, and a fifth face that extend in the first direction. The third face is positioned on the opposite side of the opening portion in the second direction. The opening portion of the first case has a larger area than each of the first face and the second face of the first case. The third face of the second case closes the opening portion of the first case.

In the above configuration, the opening portion having a larger area (opening area) than each of the two end faces (the first face and the second face) in the first direction is formed on the first case. A larger opening portion is formed on the first case, compared to a configuration in which an opening portion is formed on one of the end faces of the first case, and therefore, the first cell group is easily put in the first case through the opening portion. Further, the case has a rectangular parallelepiped shape, which is a simple shape, and therefore, is easily produced. The first case and the second case have an identical shape or similar shapes as described above, and this also contributes to the reduction in production cost. In the above configuration, the electric storage device is easily produced, and the production cost is easily reduced.

(Third Item) In the electric storage device according to the second item, the first case and the second case are joined such that the first case is sealed in a state where the first case houses the first cell group. The electric storage device further includes a lid member that closes the opening portion of the second case such that the second case is sealed in a state where the second case houses the second cell group.

In the above configuration, each case can be sealed in the state where the case houses the cell group.

(Fourth Item) The electric storage device according to any one of the first to third items, further includes a mechanism that generates force by which the second case is pressed against the first case.

In the above configuration, it is possible to lessen (or eliminate) the gap between the opening portion of the first case that houses the first cell group and the second case.

As a mode according to a second aspect of the present disclosure, the following vehicle is provided.

(Fifth Item) The vehicle includes the electric storage device according to any one of the first to fourth items.

The above vehicle includes an electric storage device having a configuration that makes it possible to restrain the increase in the dimensions or number of components and that is easily produced.

With the present disclosure, it is possible to provide the electric storage device that makes it possible to restrain the increase in the dimensions or number of components and that is more easily produced, and the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for describing the configuration of an electric storage device according to an embodiment of the present disclosure;

FIG. 2 is a diagram for describing the configuration of each cell coupling body shown in FIG. 1;

FIG. 3 is a sectional view taken along line III-III in FIG. 1;

FIG. 4 is a diagram for describing operations and effects of the electric storage device according to the embodiment of the present disclosure;

FIG. 5 is a diagram showing a first modification of the electric storage device shown in FIG. 1; and

FIG. 6 is a diagram showing a second modification of the electric storage device shown in FIG. 1.

### DETAILED DESCRIPTION OF EMBODIMENTS

An embodiment of the present disclosure will be described in detail with reference to the drawings. In the figures, identical or corresponding portions are denoted by identical reference characters, and descriptions thereof are not repeated. In each figure that is used below, an X-axis, a Y-axis, and a Z-axis are orthogonal to each other, the X-axis indicates a first in-plane direction (for example, a length direction) of the electric storage device, the Y-axis indicates a second in-plane direction (for example, a width direction) of the electric storage device, and the Z-axis indicates a height direction of the electric storage device. Hereinafter, the directions of arrows of the X-axis, the Y-axis, and the Z-axis are expressed with “+”, and the opposite directions are expressed with “−”.

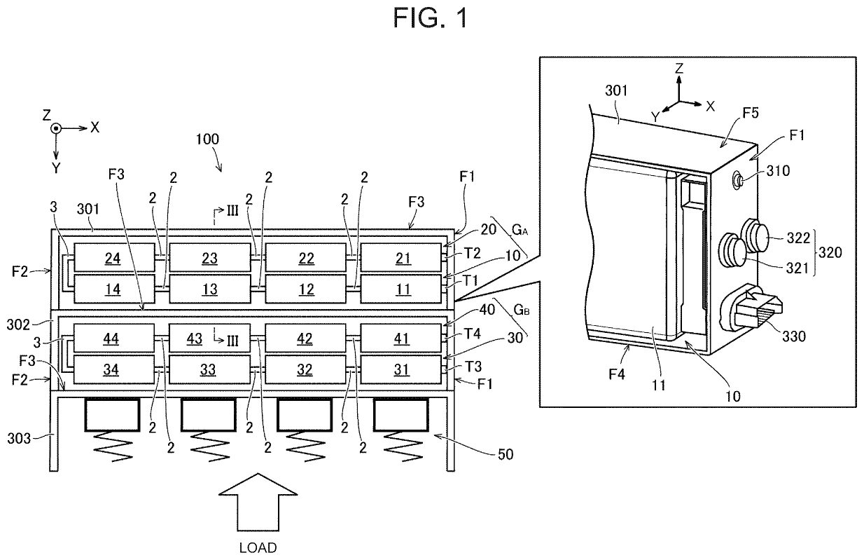

FIG. 1 is a diagram for describing the configuration of an electric storage device according to the embodiment. The electric storage device 100 according to the embodiment is configured to be capable of storing electricity. The electric storage device 100 includes a plurality of electric storage cells each of which functions as a secondary battery. Details will be described later. Examples of the secondary battery include a lithium-ion battery, a nickel-hydrogen battery, and a sodium-ion battery. Examples of the lithium-ion battery include an LFP battery in which lithium ferrous phosphate is employed as a positive electrode active material, and a ternary battery in which nickel-manganese-cobalt (NMC) is employed as a positive electrode active material. The type of the secondary battery may be a liquid secondary battery or an all-solid-state secondary battery. The electric storage device 100 may include only the same kind of electric storage cells (for example, only LFP batteries), or may include different kinds of electric storage cells (for example, LFP batteries and ternary batteries).

The interiors of cases as viewed from the +Z-side are shown on the left side of FIG. 1. The electric storage device 100 includes a case 301 (first case) that houses a cell group G_{A} (first cell group), a case 302 (second case) that houses a cell group G_{B} (second cell group), and a case 303 that houses a biasing device 50. Each of the cases 301 to 303 has a rectangular parallelepiped shape in which an opening portion is formed on the +Y-side. Each corner of the cases 301 to 303 may be beveled (for example, by rounding process). The X-direction corresponds to the longitudinal direction of each of the cases 301 to 303. In the embodiment, the X-direction and the Y-direction correspond to examples of the “first direction” and the “second direction” according to the present disclosure, respectively.

For example, metal can be employed as the material that composes each of the cases 301 to 303. For example, each of the cases 301 to 303 is a case made of aluminum. However, without being limited to this, each of the cases 301 to 303 may be a case made of resin. Further, a different material may be employed for each of sites (for example, later-described faces F1 to F5) of the cases. In the embodiment, the case 301, the case 302, and the case 303 have the same dimensions and the same shape. Therefore, as a representative, only the dimensions and shape of the case 301 will be described below in detail.

The case 301 includes faces F1, F2 that are positioned at both ends in the X-direction, and faces F3 to F5 that extend in the X-direction. The face F1 (first face) covers a +X-side end portion of the cell group G_{A} that is housed in the case 301. The face F2 (second face) covers a −X-side end portion of the cell group G_{A} that is housed in the case 301. The case 301 includes the face F3 (third face) at one end (−Y-side) in the Y-direction, and includes an opening portion at the other end (+Y-side) in the Y-direction. The face F3 is positioned on the opposite side of the opening portion in the Y-direction. In the embodiment, the opening portion is wholly formed on the face on the opposite side of the face F3, but the opening portion may be partially formed. The face F4 (fourth face) and the face F5 (fifth face) correspond to a pair of opposed faces that are opposed to each other in the Z-direction. Each of the faces F1 to F5 correspond to a plate-shaped portion that constitute the case 301. However, the shape of each of the cases 301 to 303 is not limited to the above shape.

Each of the opening portion and the face F3 on the opposite side of the opening portion has a larger area than each of the faces F1, F2. The length (the dimension in the X-direction) of the case 301 is longer than the width (the dimension in the Y-direction) of the case 301. The length of the case 301 may be 250 mm or more and 5000 mm or less, and for example, is about 1000 mm. The width of the case 301 may be 10 mm or more and 1250 mm or less, and for example, is about 50 mm. The proportion of the length of the case 301 to the width of the case 301 may be 4 or more and 25 or less. The height (the dimension in the Z-direction) of the case 301 may be 10 mm or more and 1250 mm or less, and for example, is about 100 mm. The dimensions of each of the cases 301 to 303 are not limited to the above dimensions.

In the electric storage device 100, as shown in FIG. 1, the face F3 of the case 302 closes the opening portion of the case 301. The case 301 and the case 302 are joined such that the case 301 is sealed in a state where the case 301 houses the cell group G_{A}. Further, the face F3 of the case 303 closes the opening portion of the case 302. The case 302 and the case 303 are joined such that the case 302 is sealed in a state where the case 302 houses the cell group G_{B}. The case 303 functions as a lid member that closes the opening portion of the case 302.

The biasing device 50 housed in the case 303 includes a mechanism that generates the force (the load to the −Y-side) by which the face F3 of the case 303 is pressed against the case 302. By the transmission of the force (load), the face F3 of the case 302 is further pressed against the case 301. The biasing device 50 may generate biasing force, and may give the force to the case 302 using the biasing force. The biasing device 50 may include a mechanism that mechanically generates the biasing force (for example, a mechanism that uses a spring). Further, the biasing device 50 may include a mechanism that generates the biasing force by electric power (for example, a mechanism that uses an electric actuator). Since the face F3 (plate-shaped portion) of the case 303 is pressed against the case 302, it is possible to lessen (or eliminate) the gap between the opening portion of the case 302 and the face F3 of the case 303. Further, since the face F3 (plate-shaped portion) of the case 302 is pressed against the case 301, it is possible to lessen (or eliminate) the gap between the opening portion of the case 301 and the face F3 of the case 302. Since the opening portion of each of the cases 301, 302 is closed by another case (case 302 or 303) in this way, the airtightness of the cases 301, 302 is enhanced. In order that the face pressure due to the above force (load) is uniformly given to the cases 301, 302, an elastic body and/or an adhesive agent may be provided between the case 301 and the case 302 and between the case 302 and the case 303.

In the electric storage device 100, the cases 301 to 303 (three housings each of which includes the opening portion on the +Y-side) are stacked in the Y-direction. Thereby, the volumetric efficiency of the electric storage device 100 is enhanced. Further, the opening portion of the case 303 that is at the outermost position on the +Y-side among the cases 301 to 303 is not closed and is opened. Thereby, the heat dissipation of a housing portion (including the biasing device 50) of the case 303 is enhanced. However, without being limited to this structure, the opening portion of the case 303 may be closed by an unillustrated lid member.

On the face F1 of each of the cases 301, 302, components for managing the housed cell group are provided. The face F1 of the case 301 and the face F1 of the case 302 have the same structure, and therefore, as a representative, an enlarged view of the face F1 of the case 301 is shown on the right side in FIG. 1. A sealing hole 310, an external terminal 320, and a connector 330 are provided on the face F1 of each of the cases 301, 302. The sealing hole 310 may be a pressure regulation hole that regulates the pressure in the case. For example, the sealing hole 310 has a seal structure that is constituted by a metal cap (case outer side) and a seal member (case inner side). By this seal structure, the airtightness of the case is secured, and when the pressure in the case exceeds a predetermined level, gas is emitted to the exterior of the case through the sealing hole 310. The external terminal 320 includes an electrode tab 321 that is joined to a first connection terminal of the cell group (for example, by laser welding), and an electrode tab 322 that is joined to a second connection terminal of the cell group (for example, by laser welding). For example, at the external terminal 320 provided on the face F1 of the case 301, the electrode tab 321 is joined to a connection terminal T1 of the cell group G_{A}, and the electrode tab 322 is joined to a connection terminal T2 of the cell group G_{A}. Further, at the external terminal 320 provided on the face F1 of the case 302, the electrode tab 321 is joined to a connection terminal T3 of the cell group G_{B}, and the electrode tab 322 is joined to a connection terminal T4 of the cell group G_{B}. Each of the electrode tabs 321, 322 may have an insulating seal structure with ceramic, around an electrode, for example. In the embodiment, the electrode tabs 321, 322 function as a negative electrode tab and a positive electrode tab, respectively. However, without being limited to this, polarities may be reversed such that the electrode tab 322 is the negative electrode tab and the electrode tab 321 is the positive electrode tab. For example, the connector 330 includes an output terminal that outputs a detection signal indicating the state (for example, the temperature of each electric storage cell) in the case that is detected by one or more sensors in the case, to the exterior of the case, and an input terminal that inputs a control signal from the exterior of the case to one or more devices in the case. For example, a temperature sensor may be provided for each electric storage cell in the case. The structure of the face F1 of each case is not limited to the above structure, and can be altered when appropriate. For example, a pressure regulation valve for vacuum may be provided at the sealing hole 310 of each of the cases 301, 302, and the interiors of the cases 301, 302 may be vacuumized. Further, at least one of a pressure regulation hole and a gas emission valve may be provided on the face F2 of each of the cases 301, 302.

Each of the cell group G_{A} and the cell group G_{B} includes a plurality of electric storage cells that is connected in the X-direction. More specifically, the cell group G_{A} includes a cell coupling body 10 (first cell coupling body) and a cell coupling body 20 (second cell coupling body) that are electrically connected. The cell group G_{B} includes a cell coupling body 30 (first cell coupling body) and a cell coupling body 40 (second cell coupling body) that are electrically connected. Each electric storage cell included in the cell coupling bodies is configured to be capable of storing electricity.

The cell coupling body 10 includes four electric storage cells 11 to 14 that are arrayed in the X-direction, and three connection portions 2 that electrically connect the electric storage cells 11 to 14. The electric storage cells 11 to 14 are connected on a line in the X-direction within the case 301. The cell coupling body 20 includes four electric storage cells 21 to 24 that are arrayed in the X-direction, and three connection portions 2 that electrically connect the electric storage cells 21 to 24. The electric storage cells 21 to 24 are connected on a line in the X-direction within the case 301. In this way, the cell coupling body 10 and the cell coupling body 20 are disposed parallel in the X-direction. In the embodiment, the cell coupling bodies 10, 20 are disposed such that the positions of the electric storage cells and the connection portions are arranged. The connection terminal T1 is provided at a +X-side end portion (electric storage cell 11) of the cell coupling body 10, and the connection terminal T2 is provided at a +X-side end portion (electric storage cell 21) of the cell coupling body 20. The electric storage cells 11, 21 are electrically connected to the electrode tabs 321, 322 (face F1) of the case 301 through the connection terminals T1, T2, respectively. A −X-side end portion (electric storage cell 14) of the cell coupling body 10 and a −X-side end portion (electric storage cell 24) of the cell coupling body 20 are electrically connected, for example, through a U-shaped connection portion 3, within the case 301.

The cell coupling body 30 includes four electric storage cells 31 to 34 that are arrayed in the X-direction, and three connection portions 2 that electrically connect the electric storage cells 31 to 34. The electric storage cells 31 to 34 are connected on a line in the X-direction within the case 302. The cell coupling body 40 includes four electric storage cells 41 to 44 that are arrayed in the X-direction, and three connection portions 2 that electrically connects the electric storage cells 41 to 44. The electric storage cells 41 to 44 are connected on a line in the X-direction within the case 302. In this way, the cell coupling body 30 and the cell coupling body 40 are disposed parallel in the X-direction. In the embodiment, the cell coupling bodies 30, 40 are disposed such that the positions of the electric storage cells and the connection portions are arranged. The connection terminal T3 is provided at a +X-side end portion (electric storage cell 31) of the cell coupling body 30, and the connection terminal T4 is provided at a +X-side end portion (electric storage cell 41) of the cell coupling body 40. The electric storage cells 31, 41 are electrically connected to the electrode tabs 321, 322 (face F1) of the case 302 through the connection terminals T3, T4, respectively. A −X-side end portion (electric storage cell 34) of the cell coupling body 30 and a −X-side end portion (electric storage cell 44) of the cell coupling body 40 are electrically connected, for example, through a U-shaped connection portion 3, within the case 302.

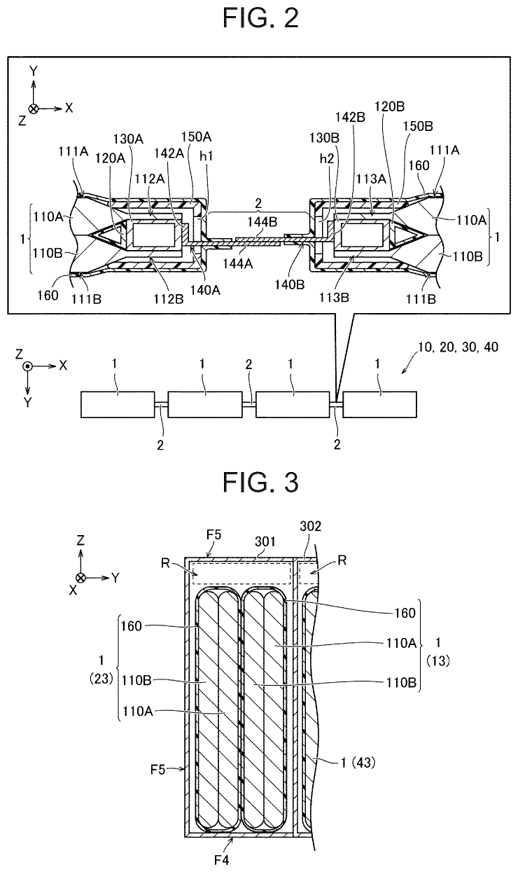

The connection portion 3 of each of the cell groups G_{A}, G_{B} may be an integrally molded article, or may be a composite of a plurality of separately molded components. For example, the connection portion 3 may be formed by connecting a protrusion portion 144B (FIG. 2) that protrudes from the electric storage cell 14 or 34 and a protrusion portion 144B (FIG. 2) that protrudes from the electric storage cell 24 or 44 through a conductive material (joist portion). The protrusion portion 144B will be described later.

In the embodiment, the cell coupling bodies 10, 20, 30, 40 basically have the same configuration. Hereinafter, the electric storage cells 11 to 14, 21 to 24, 31 to 34, 41 to 44 are referred to as “electric storage cells 1”, when they are not distinguished.

FIG. 2 is a diagram for describing the configuration of each cell coupling body. As shown in FIG. 2, each cell coupling body includes four electric storage cells 1. Moreover, the connection portion 2 is provided between adjacent electric storage cells 1, and the connection portion 2 electrically connects the electric storage cells 1. Each cell coupling body is configured such that the electric storage cell 1 and the connection portion 2 are alternately arrayed. In each cell coupling body, the electric storage cells 1 are connected to each other through the connection portion 2. The stiffness of the connection portion 2 is lower than the stiffness of the electric storage cell 1. The electric storage cells 11 to 14, 21 to 24, 31 to 34, 41 to 44 are constituted by the same electric storage cell 1. Since the cell coupling bodies 10, 20, 30, 40 are formed using the common electric storage cell 1, the electric storage device 100 is easily produced, and the production cost can be reduced.

In the embodiment, the electric storage cell 1 is a laminate cell that includes one or more wound bodies. In the laminate cell, one or more wound bodies that function as electrode bodies is covered with a laminate exterior packaging body. For example, the wound body has a structure in which a positive electrode sheet and a negative electrode sheet are wound such that a separator is interposed. Each of the positive electrode sheet and the negative electrode sheet includes an electrode foil and an active material layer.

The structures of the electric storage cell 1 and the connection portion 2 will be described below using a sectional view (an X-Y sectional view of the periphery of the connection portion 2) in FIG. 2. The electric storage cell 1 includes two wound bodies 110A, 110B, spacers 120A, 120B, terminal members 130A, 130B, and covers 150A, 150B.

The wound bodies 110A, 110B include coated portions 111A, 111B, electrode tabs 112A, 112B, and electrode tabs 113A, 113B, respectively. Each of the coated portions 111A, 111B is a region where the active material layer of the electrode foil of the positive electrode sheet or the negative electrode sheet is provided. Each of the electrode tabs 112A, 112B, 113A, 113B is a region where the electrode foil is exposed on the positive electrode sheet or the negative electrode sheet (an uncoated portion where the active material layer is not provided). The electrode tabs 112A, 112B are positioned at +X-side end portions of the wound bodies 110A, 110B, respectively. The electrode tabs 113A, 113B are positioned at −X-side end portions of the wound bodies 110A, 110B, respectively.

The electrode tab 112A and the electrode tab 112B are disposed so as to overlap in the Y-direction, and the spacer 120A and the terminal member 130A are provided between the electrode tab 112A and the electrode tab 112B. The electrode tab 113A and the electrode tab 113B are disposed so as to overlap in the Y-direction, and the spacer 120B and the terminal member 130B are provided between the electrode tab 113A and the electrode tab 113B.

Each of the spacers 120A, 120B contains an insulating material (for example, a synthetic resin), and has an insulation property. Each of the spacers 120A, 120B has a shape in which the dimension in the Y-direction is larger at a position farther from the coated portions 111A, 111B. The terminal member 130A is connected to a +X-side end face of the spacer 120A. The terminal member 130B is connected to a −X-side end face of the spacer 120B. Each of the terminal members 130A, 130B contains a conducting material (for example, a metal such as aluminum or copper), and has a conductive property. The wound body 110A and the wound body 110B are joined to each other through the terminal members 130A, 130B (for example, by laser welding).

Each of current collecting terminals 140A, 140B is a component that constitutes a part of the connection portion 2. The current collecting terminals 140A, 140B include support portions 142A, 142B and protrusion portions 144A, 144B, respectively. One of the current collecting terminals 140A, 140B functions as a positive electrode current collecting terminal, and the other of current collecting terminals 140A, 140B functions as a negative electrode current collecting terminal. As an example, the positive electrode current collecting terminal is formed of aluminum, and the negative electrode current collecting terminal is formed of copper.

Each of the current collecting terminals 140A, 140B, which is formed in an L-shape, may be formed by joining two plate members that are separately molded, or may be formed by bending process in an integral state. The support portion 142A is joined to a +X-side end face of the terminal member 130A (for example, by laser welding). The support portion 142B is joined to a −X-side end face of the terminal member 130B (for example, by laser welding).

The cover 150A covers a +X-side end portion (including the electrode tabs 112A, 112B) of the electric storage cell 1. A through-hole h1 for the protrusion portion 144A is provided on the cover 150A. The protrusion portion 144A passes through the through-hole h1, and protrudes to the +X-side of the electric storage cell 1. Further, the cover 150B covers a −X-side end portion (including the electrode tabs 113A, 113B) of the electric storage cell 1. A through-hole h2 for the protrusion portion 144B is provided on the cover 150B. The protrusion portion 144B passes through the through-hole h2, and protrudes to the −X-side of the electric storage cell 1.

At the connection portion 2, the protrusion portion 144A that protrudes from one electric storage cell 1 of the two adjacent electric storage cells 1 and the protrusion portion 144B that protrudes from the other electric storage cell 1 are joined (for example, by laser welding). The welded portion may be protected by a tape or the like. A laminate exterior packaging body 160 is provided on surfaces of the two wound bodies 110A, 110B. The laminate exterior packaging body 160 is a laminate film, for example, and is provided on a surface of the electric storage cell 1.

FIG. 3 is a sectional view taken along line III-III in FIG. 1. Each of the cases 301 to 303 shown in FIG. 1 has a U-shaped section shown in FIG. 3, as a section (Y-Z section) orthogonal to the X-direction. Further, in each of the cases 301, 302, a region R exists between the +Z-side face of each electric storage cell and an inner face (top face) of the case. At the region R, at least one of a heat management system (for example, a heater and/or a temperature sensor), a gas emission system (for example, a gas flow passage and/or a pressure sensor), a flexible printed circuit board (FPC), and a wire that is connected to the connector 330 may be provided. Devices and/or sensors provided at the region R may be connected to the connector 330. Each electric storage cell housed in cases 301, 302 may be caused to adhere to the inner face of the case by an adhesive agent.

The above configuration is just an example of the configuration of the electric storage cell 1, and can be altered when appropriate. For example, the number of wound bodies that are included in the electric storage cell 1 is not limited to two, and may be one, or may be three or more. Further, as the electrode body, a laminated body (for example, a laminated body in which a positive electrode sheet and a negative electrode sheet are laminated such that a separator is interposed) may be employed instead of the wound body. Further, for example, an insulating layer containing a resin such as polyethylene terephthalate (PET) may be provided on the inner face of each case.

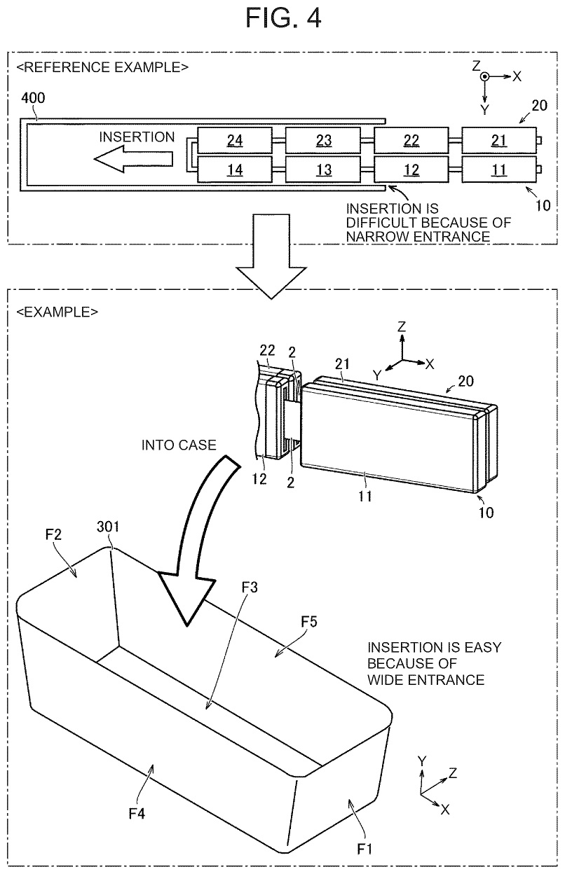

FIG. 4 is a diagram for describing operations and effects of the electric storage device 100. In a mode in which the electrically connected cell coupling bodies 10, 20 are housed in a case 400 having a bottomed tubular shape and including an opening portion on the +X-side end face as shown in a reference example in FIG. 4, there can be a problem in that it is difficult to insert the cell coupling bodies 10, 20 into the case 400. Further, in this reference example, for causing the interior of the case 400 to be in a sealed state, a lid member for closing the opening portion of the case 400 is necessary. In contrast, in the electric storage device 100 shown in FIG. 1 to FIG. 3, the opening portion of the case 301 that houses the cell group G_{A} is closed by the case 302 that houses another cell group (cell group G_{B}), and therefore, it is not necessary to separately provide the lid member for closing the opening portion of the case 301. Thereby, the increase in the number of components is restrained. Further, the case 301 includes the opening portion having a size that allows the cell group G_{A} to easily pass (specifically, a size equivalent to the size of the face F3 on the opposite side). Since the entrance (opening) of the case 301 is wide, the cell group G_{A} is easily put in the case 301. Moreover, the case 302 has the same shape and dimensions as the case 301, and therefore, the opening portion of the case 301 can be closed by the face F3 of the case 302. Furthermore, the case 302 includes the opening portion having a size that allows the cell group G_{B} to easily pass (specifically, a size equivalent to the size of the face F3 on the opposite side). Since the entrance (opening) of the case 302 is wide, the cell group G_{B} is easily put in the case 302. Moreover, the case 303 has the same shape and dimensions as the case 302, and therefore, the opening portion of the case 302 can be closed by the face F3 of the case 303.

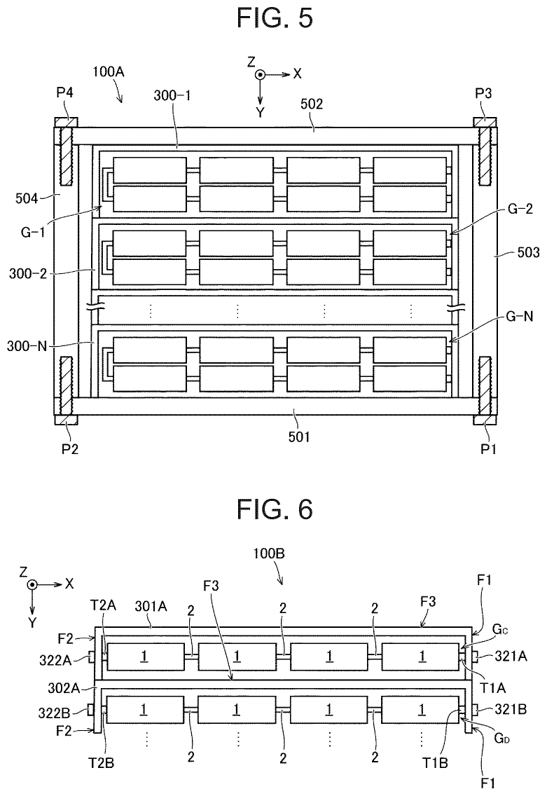

The number of cases that house cell groups is not limited to two, and may be three or more. FIG. 5 is a diagram showing a first modification of the electric storage device 100.

As shown in FIG. 5, an electric storage device 100A according to the first modification includes N cases (cases 300-1, 300-2, . . . , 300-N) and N cell groups (cell groups G-1, G-2, . . . , G-N). Specifically, the electric storage device 100A includes cases 300-1 to 300-N and cell groups G-1 to G-N that are housed in the cases 300-1 to 300-N, respectively. Each of the cell groups G-1 to G-N has the same configuration as the above-described cell group G_{A} (see FIG. 1 to FIG. 3). N may be 3 or more and less than 20, or may be 20 or more.

Each of the cases 300-1 to 300-N has the same shape as the above-described case 301 (see FIG. 4). As shown in FIG. 5, the cases 300-1 to 300-N are stacked in the Y-direction. The electric storage device 100A further includes a constraining tool that constrains the cases (laminated body) in the Y-direction. The constraining tool includes pressing plates 501, 502, connection shafts 503, 504, and bolts P1 to P4. The pressing plate 501 is coupled to the connection shafts 503, 504 by the bolts P1, P2, respectively. Further, the pressing plate 502 is coupled to the connection shafts 503, 504 by the bolts P3, P4, respectively. By tightening the bolts P1 to P4, the pressure (constraining force) in the Y-direction is given to the laminated body (cases 300-1 to 300-N). The interior of each case may be vacuumized, and the constraining pressure may be increased.

The opening portion of each of the cases 300-1 to 300-N is closed. The opening portion of the case 300-N that is at the outermost position on the +Y-side among the cases 300-1 to 300-N is closed by the pressing plate 501 (for example, a flat plate member), and the opening portion of each of the other cases is closed by the case that is at the adjacent position (on the +Y-side). The pressing plate 501 functions as a lid member that closes the opening portion of the case 300-N. The constraining force may be given to the laminated body (cases 300-1 to 300-N), such that the pressing plate 501 presses the case 300-N hard, and thereby, the airtightness of each case may be increased. In order that the face pressure by the constraining tool is uniformly given to the case 300-N, an elastic body and/or an adhesive agent may be provided between the case 300-N and the pressing plate 501. Each case may be constrained by a band (for example, a rubber band), instead of the bolts (fastening).

The number of cell coupling bodies that are housed in the case is not limited to two, and may be an arbitrary number. The number of cell coupling bodies that are housed in the case may be three or more, or may be one. FIG. 6 is a diagram showing a second modification of the electric storage device 100.

As shown in FIG. 6, an electric storage device 100B according to the second modification includes a case 301A (first case) that houses a cell group Gc (first cell group), and a case 302A (second case) that houses a cell group GD (second cell group). Each of the cell groups Gc, Gp is one cell coupling body that has the configuration shown in FIG. 2.

Each of the cases 301A, 302A basically has the same shape as the above-described case 301 (see FIG. 4). However, in the case 301A, an electrode tab 321A is provided on the face F1, and an electrode tab 322A is provided on the face F2. Moreover, an electric storage cell 1 positioned at one X-directional end (+X-side) of the cell coupling body that is housed in the case 301A includes a connection terminal T1A that is electrically connected to the electrode tab 321A. Further, an electric storage cell 1 positioned at the other X-directional end (−X-side) of the cell coupling body that is housed in the case 301A includes a connection terminal T2A that is electrically connected to the electrode tab 322A. Further, in the case 302A, an electrode tab 321B is provided on the face F1, and an electrode tab 322B is provided on the face F2. Moreover, an electric storage cell 1 positioned at the one X-directional end (+X-side) of the cell coupling body that is housed in the case 302A includes a connection terminal T1B that is electrically connected to the electrode tab 321B. Further, an electric storage cell 1 positioned at the other X-directional end (−X-side) of the cell coupling body that is housed in the case 302A includes a connection terminal T2B that is electrically connected to the electrode tab 322B.

In the electric storage device 100B, the face F3 of the case 302A closes the opening portion of the case 301A. Thereby, the cell group Gc is protected while being surrounded by the cases 301A, 302A. Further, a lid member may be provided on the +Y-side of the case 302A, and the opening portion of the case 302A may be closed by the lid member. In this configuration, the cell group Gp is protected while being surrounded by the case 302A and the lid member. The lid member may be another case that houses the cell group, or may be a lid member that has a flat plate shape.

The configuration of each cell coupling body is not limited to the configuration shown in FIG. 2. Each cell coupling body may include electric storage cells having different dimensions, and may include electric storage cells having different shapes. The number of the electric storage cells that are included in each cell coupling body may be less than 4, may be 5 or more and 19 or less, or may be 20 or more.

All cases that house cell groups do not need to have the same shape. Further, all cases that house cell groups do not need to be sealed. For example, the electric storage device 100 shown in FIG. 1 may be altered to a configuration in which the case 302 is opened in a state where the case 302 houses the cell group G_{B}, by removing the case 303 and the biasing device 50 from the electric storage device 100. Since the case 302 is opened, the heat dissipation of the cell group G_{B} can be enhanced.

The above-described electric storage devices 100, 100A, 100B can be equipped in a movable body, for example. Examples of the movable body include a vehicle (a battery electric vehicle, hybrid electric vehicle, and the like), a conveyance (a ship, an airplane, and the like) other than the vehicle, a movable machine (an agricultural machine, a construction machine, and the like), and an unmanned movable body (an unmanned carrier, a robot, and the like). The electric storage device is used for an arbitrary purpose, and may be a stationary electric storage device.

Various characteristics relevant to the above-described electric storage devices (characteristics described in the embodiment and the modifications) may be carried out while being arbitrarily combined.

It should be understood that the embodiment and modifications disclosed herein are examples and are not limitative in all respects. It is intended that the scope of the present disclosure is shown not by the above descriptions of the embodiment and the modifications but by the claims and includes all alterations within meanings and ranges equivalent to the claims.

What is claimed is:

1. An electric storage device comprising:
a first case that houses a first cell group; and
a second case that houses a second cell group, wherein:
each of the first cell group and the second cell group includes a plurality of electric storage cells that is connected in a first direction;
the first case includes an opening portion at one end in a second direction orthogonal to the first direction; and
the first case and the second case are disposed such that the second case closes the opening portion of the first case.

2. The electric storage device according to claim 1, wherein:
each of the first case and the second case has a rectangular parallelepiped shape in which an opening portion is provided at one end in the second direction;
each of the first case and the second case includes a first face and a second face that are positioned at both ends in the first direction, and a third face, a fourth face, and a fifth face that extend in the first direction;
the third face is positioned on an opposite side of the opening portion in the second direction;
the opening portion of the first case has a larger area than each of the first face and the second face of the first case; and
the third face of the second case closes the opening portion of the first case.

3. The electric storage device according to claim 2, wherein:
the first case and the second case are joined such that the first case is sealed in a state where the first case houses the first cell group; and
the electric storage device further comprises a lid member that closes the opening portion of the second case such that the second case is sealed in a state where the second case houses the second cell group.

4. The electric storage device according to claim 1, further comprising a mechanism that generates force by which the second case is pressed against the first case.

5. A vehicle comprising the electric storage device according to claim 1.
